(19) United States
(12) Patent Application Publication
(10) Pub. No.: US 2004/0177989 A1
(43) Pub. Date: Sep. 16, 2004

(54) Screwed cable gland

(75) Inventors: Andreas Nass, Warmsen (DE); Martin Schmidt, Lubbecke (DE)

Correspondence Address: HAYES, SOLOWAY P.C., 130 W. CUSHING STREET, TUCSON, AZ, 85701, US

(73) Assignee: HARTING Electric GmbH & Co. KG

(21) Appl. No.: 10/790,886

(22) Filed: Mar. 2, 2004

(30) Foreign Application Priority Data
Mar. 15, 2003 (DE) 103 11 473.4

(51) Int. Cl. H02G 3/00

(52) U.S. Cl. 174/65 SS

(57) ABSTRACT

In order to insert a prefabricated electric cable with a connector insert already mounted thereon into a plug connector housing with a cable connection piece, the invention proposes to realize the plug connector housing in the form of two interconnectable housing halves, wherein the connector insert with the cable connected thereto is installed into the plug connector housing.

Slotted sealing elements as well as two joinable screw elements that are centrally partitioned in the longitudinal direction are provided in order to seal and relieve the strain on the cable that protrudes from the cable connection piece. The sealing elements and the screw elements are placed around the cable and connected such that a screwed cable gland is formed.

The invention pertains to a screwed cable gland that is screwed on a connection piece of a plug connector housing, wherein the plug connector housing consists of two interconnectable shells that are centrally partitioned in the longitudinal direction, and wherein the plane of partition extends through the center of the cable connection piece.

A cable connection of this type which consists of a joinable screw element and slotted sealing elements is required for installing prefabricated cables that already are rigidly connected to connector inserts or plug-type connectors in a cable connection piece of a plug connector housing that consists of two housing shells. In this case, the separable screw element and the slotted sealing elements are placed around the cable and screwed into the cable connection piece.

Until now, plug connector housings with prefabricated electric cables and connector inserts already mounted thereon were used in the interior of protected systems, e.g., in switchboxes.

In this case, the switchbox protects the plug connector housing from the industrial environment such that the plug connector housing only needs to fulfill the functions of rigidly locking the installed plug-type connector in place, of protecting persons from accidental contact with live components and of relieving the strain on the cable. In applications outside protected systems, corresponding precautions must be taken, and the plug connector housing needs to be designed in a correspondingly stable fashion and reliably protected from environmental influences.

The invention is based on the objective of installing a prefabricated electric cable that is already provided with plug-type connectors into a plug connector housing that consists of two shells, as well as to provide corresponding screw connection elements and sealing elements that can be mounted on an already installed cable.

This objective is attained due to the fact that the screwed cable gland consists of a screw element that is composed of two joinable parts that encompass the cable inserted into the cable connection piece and on which an outside thread is provided, the fact that the cable connection piece is provided with a thread, into which the screw element can be screwed, and the fact that the cable connection piece has a shoulder that is contacted by a slotted sealing element that encompasses the cable and is compressed when the screw element is screwed into the cable connection piece.

Advantageous embodiments of the invention are defined in claims 2-8.

The particular advantage of the invention is that a prefabricated electric cable with a connector insert or a plug-type connector mounted thereon can be inserted into a plug connector housing composed of two shells.

The screw element—also referred to as pressing screw—that is screwed into the housing and serves for fixing the cable, as well as a corresponding sealing element that is adjoined by thrust washers on both sides, preferably are interrupted at least in one location in the form of a slot such that they can be separated and reconnected once they are placed around the cable.

Various options may be considered for holding together the two parts of the screw element, wherein the described sliding connections are realized in the form of positive connections and can be manufactured quite easily with modern injection techniques.

In this case, the basic form advantageously consists of a tongue-and-groove connection.

All screw elements according to the invention essentially have of a buckled T-shape, wherein the upper section is realized in the form of a hexagon such that relatively high tightening forces already can be exerted manually. The lower section of the screw element is provided with an outside thread that is screwed into the inside thread of the cable connection piece of an assembled and fitted plug connector housing.

One embodiment of the invention is illustrated in the figures and described in greater detail below. The figures show:

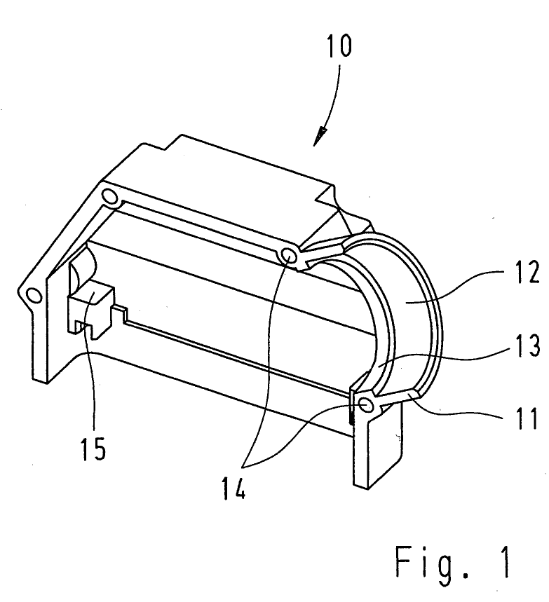

FIG. 1, an open half of a housing shell;

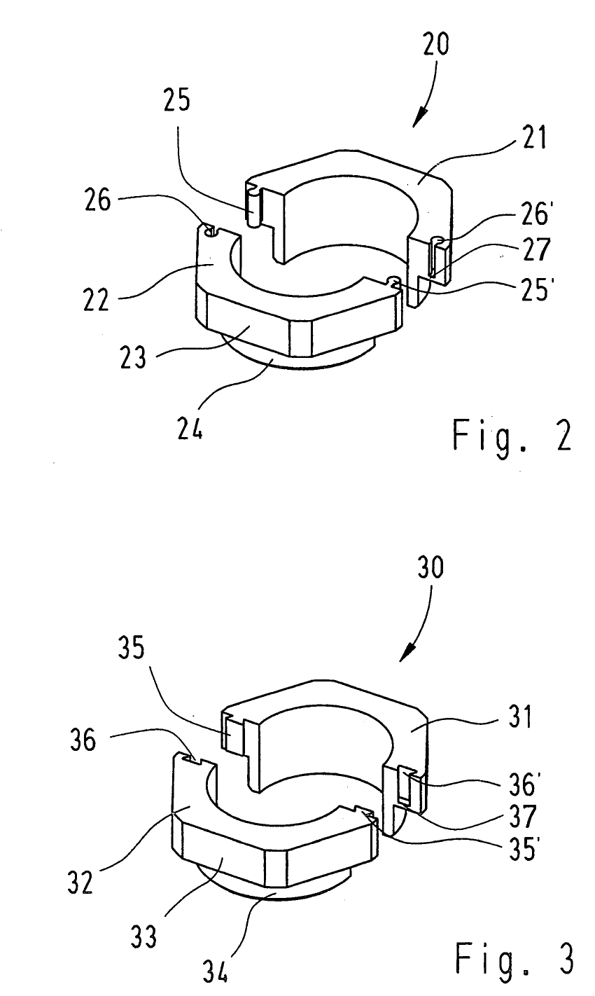

FIG. 2, two halves of a screw element with pin;

FIG. 3, two halves of a screw element with dovetail;

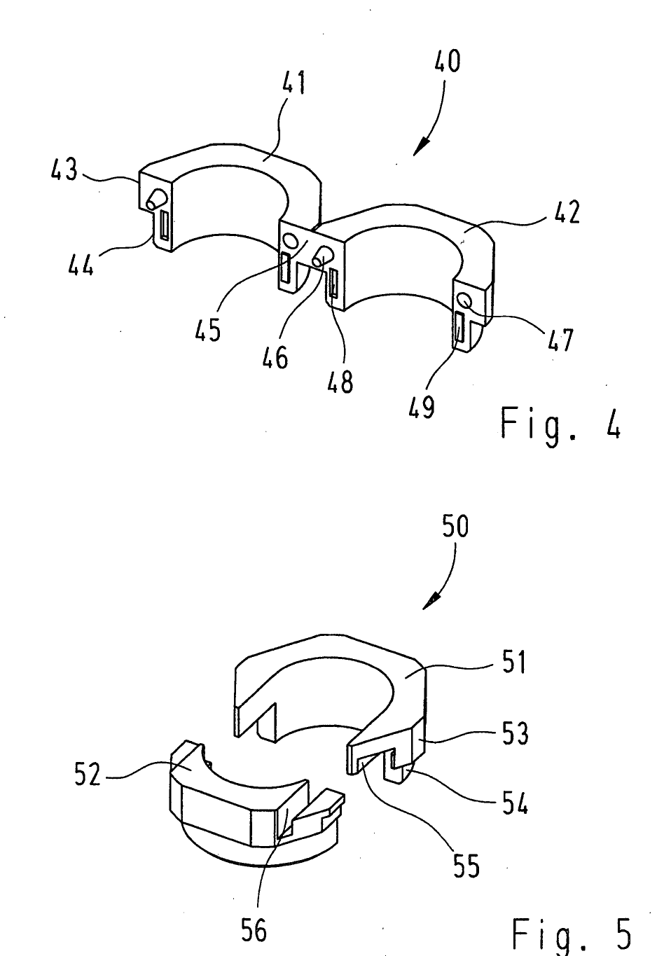

FIG. 4, two halves that are connected by means of an integral hinge;

FIG. 5, two halves of a screw element with radial guides, and

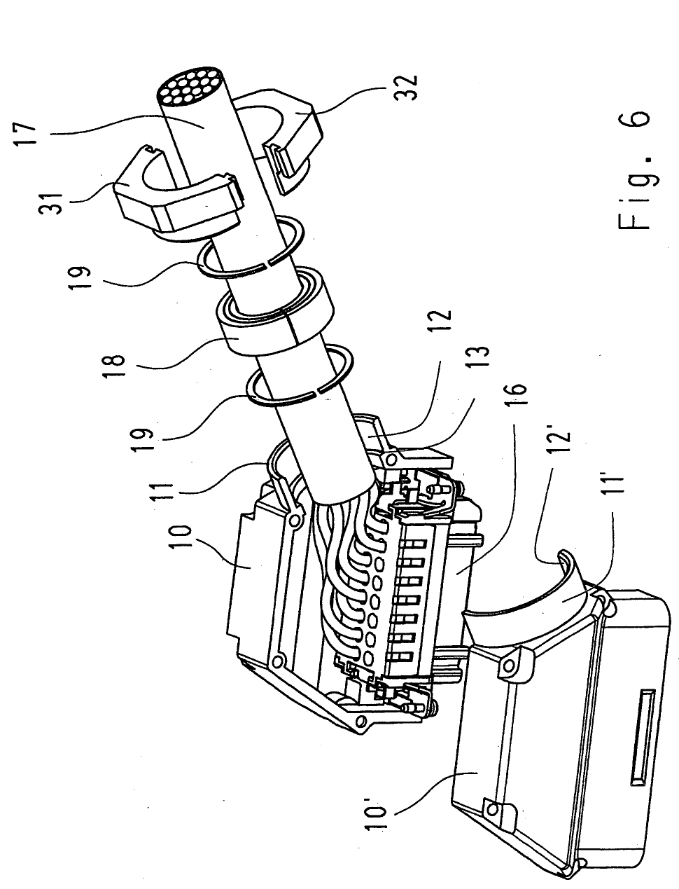

FIG. 6, an aspect of the assembled plug connector with the screwed cable gland.

FIG. 1 shows a housing shell 10 that forms a plug connector housing once it is connected to a second housing shell, wherein a connector insert 16 for connecting electrical lines can be installed into this plug connector housing. The two housing shells are held together with screw connections, wherein bores 14 are provided in the corner regions for this purpose.

The housing shell 10 contains a collar half 11 that forms the cable connection piece together with a second housing shell. An inside thread 12 is provided on the inner side of the cable connection piece. On the side of the housing interior, the end of the collar is also provided with a shoulder 13.

Slot-like holding arrangements 15 are provided in the inner corner regions of the housing shell in order to mount a connector insert 16, wherein sheet metal angles on the connector insert 16 are inserted into the aforementioned slots (see also FIG. 6).

FIG. 2 shows a screw element 20 that is composed of two nearly symmetrical parts 21, 22. The parts are centrally partitioned and essentially have a buckled T-shape, wherein the upper section of the assembled screw element is realized in the form of a hexagon 23 and an outside thread 24 is provided on the lower section.

A positive sliding connection is respectively provided in the plane of partition of the screw element parts, wherein this sliding connection comprises an axially aligned tongue 25, 25′ and a corresponding groove 26, 26′ for receiving the tongue. When installing the screw element, both parts are axially pushed together with the aid of the tongue 25 and the groove 26, as well as the tongue of 25′ and the groove 26′, wherein the slightly shorter tongue 25′ comes in contact with a limit stop 27 underneath the groove 26′ such that one part cannot be pushed through the other part.

FIG. 3 shows a variation of FIG. 2 in the form of a screw element 30, in which the positive connection between the two parts 31, 32 is realized in the form of a dovetail connection. In this case, a projection 35, 35′ can be axially inserted into a channel 36, 36′, wherein the slightly shorter projection 35′ comes in contact with a limit stop 37 underneath the groove 36′. The upper section of the screw element is realized in the form of a hexagon 33 and an outside thread 34 is provided on the lower section.

FIG. 4 shows a screw element 40 that is composed of two parts 41, 42 and held together in the open state by means of an integral hinge 45. In other respects, the screw element is realized symmetrically. The upper section is provided with a hexagon 43 and an outside thread 44 is provided on the lower section.

Pins 46 and depressions 47 for the pins are provided in the plane of partition of the two parts in order to ensure a precise fit of the screw element when the two halves are joined.

In addition, snap-in means 48, 49 are provided for holding together the two parts.

FIG. 5 shows a screw element 50 that is composed of differently shaped parts 51, 52. In this case, the upper section is realized in the form of a hexagon 53 and an outside thread 54 is provided on the lower section.

This screw element is assembled by radially displacing the two parts 51, 52, wherein one respective guide rail 55 is provided in the hexagonal region 53 of the part 51, and wherein this guide rail can be inserted into a correspondingly shaped longitudinal groove 56 of the part 52.

In this context, it would be possible, in principle, to choose any arbitrary contour that makes it possible to push together the two parts linearly in one plane. In the embodiment shown, a rectangular shape was chosen, wherein a recess in one half cooperates with a correspondingly shaped element on the other half.

In order to properly hold an electric cable in the cable connection piece and to simultaneously protect the housing interior from environmental influences, the cable needs to be surrounded by a sealing element that can be tightly screwed into the cable connection piece by means of the screw element such that the sealing element not only fulfills a sealing function, but also serves for relieving the strain on the cable.

The sealing element is adjoined by thrust washers on both sides. These thrust washers make it possible for the different materials to slide relative to one another when the sealing element is screwed into the cable connection piece with the aid of the screw element.

FIG. 7 shows an exploded view of the installation of a prefabricated cable into a plug connector housing.

In this case, the connector insert 16 is already installed into the shell 10 together with the electric cable 17, wherein this shell is ultimately connected to a second shell 10′.

A ring seal 18 and two thrust washers 19 are then placed over the cable 17 in the sequence shown in FIG. 7. These elements are interrupted in one location such that they can be spread apart and placed around the cable.

The washers are then inserted into the cable connection piece of the plug connector housing that is composed of the two collar halves 11, 11′, namely until the first washer 19 contacts the shoulder 13. Subsequently, the screw element 30 with the two parts 31, 32 is also placed around the cable, joined and screwed into the cable connection piece until the ring seal 18 tightly encompasses the cable 17.

1. A screwed cable gland that is screwed on a cable connection piece of a plug connector housing, wherein the plug connector housing consists of two interconnectable shells (10, 10′) that are centrally partitioned in the longitudinal direction, and wherein the plane of partition extends through the center of the cable connection piece (11, 11′), characterized in that the screwed cable gland consists of a screw element (20, 30, 40, 50) that is composed of two joinable parts, on which an outside thread (24, 34, 44, 54) is provided, wherein the parts encompass a cable (17) that is inserted into the cable connection piece, in that the cable connection piece (11, 11′) is provided with a thread (12, 12′), into which the screw element can be screwed, and in that the cable connection piece (11, 11′) has a shoulder (13) that is adjoined by a slotted sealing element (18) that encompasses the cable (17) and is compressed when the screw element is screwed into the cable connection piece (11, 11′).

2. The screwed cable gland according to claim 1, characterized in that the plane of partition of the parts (21, 22) of the screw element (20) contains integral round pins (25, 25′) that are respectively arranged on opposite sides and oriented in the screwing direction, wherein said round pins engage into corresponding recesses (26, 26′) and come in contact with a limit stop (27).

3. The screwed cable gland according to claim 1, characterized in that the plane of partition of the parts (31, 32) of the screw element (30) contains a dovetail guide with a tongue (35, 35′) and a groove (36, 36′) that are respectively arranged on opposite sides and oriented in the screwing direction, wherein the tongue (35′) comes in contact with a limit stop (37).

4. The screwed cable gland according to claim 1, characterized in that the parts (41, 42) of the screw element (40) are held together by means of a hinge (45), wherein the plane of partition contains pins (46) that are respectively arranged on opposite sides and engage into depressions 47, and wherein snap-in means (48, 49) are provided in order to hold together the screw elements.

5. The screwed cable gland according to claim 1, characterized in that the parts (51, 52) of the screw element (50) can be pushed together radially with the aid of positive guide means (55, 56).

6. The screwed cable gland according to claim 1, characterized in that the sealing element (18) is realized in the form of a flexible slotted ring.

7. The screwed cable gland according to claim 1, characterized in that thrust washers (19) in the form of slotted rings are provided to both sides of the sealing element (18).

8. The screwed cable gland according to at least one of the preceding claims, characterized in that the screw elements (20, 30, 40, 50) have a hexagonal shape.
